(19) United States
(12) Patent Application Publication
(10) Pub. No.: US 2014/0118400 A1
(43) Pub. Date: May 1, 2014

(54) METHOD OF AUTOMATIC UPDATING AND FILTERING INFORMATION

(71) Applicant: ASUSTeK COMPUTER INC., Taipei (TW)

(72) Inventors: Chi-Nien CHEN, Taipei (TW); Yi-Lung TSAI, Taipei (TW); Kuo-Chung CHIU, Taipei (TW); Hsiao-Kai LI, Taipei (TW); Wen-Chieh TSENG, Taipei (TW)

(73) Assignee: ASUSTeK COMPUTER INC., Taipei (TW)

(21) Appl. No.: 14/054,523

(22) Filed: Oct. 15, 2013

Related U.S. Application Data
(60) Provisional application No. 61/718,497, filed on Oct. 25, 2012.
(60) Provisional application No. 61/740,454, filed on Dec. 21, 2012.

(30) Foreign Application Priority Data
Jun. 28, 2013 (TW) 102123322

(51) Int. Cl. G06F 3/0487; G09G 5/14

(52) U.S. Cl. CPC G06F 3/0487; G09G 5/14
USPC 345/635; 345/156; 345/173

(57) ABSTRACT

A method of automatic updating and filtering information applied to an electronic display device is provided. The electronic display device includes a user interface, at least one detecting unit and a processing unit, and the user interface includes a first displaying zone and a second displaying zone. The method includes the following steps. First, the detecting unit generates a detecting signal according to an action of the electronic display device and transmits the detecting signal to the processing unit. Then, the processing unit downloads first update information and second information from a server according to users' profile and the detecting signal. The priority of the first update information is higher than the second update information. Then, the first update information and the second update information are respectively shown on the first displaying zone and the second displaying zone.

### CROSS-REFERENCE TO RELATED APPLICATION

This application claims the priorities benefit of Taiwan application No. 102123322 filed on Jun. 28, 2013, U.S. provisional application No. 61/718,497 filed on Oct. 25, 2012, and U.S. provisional application No. 61/740,454 filed on Dec. 21, 2012. The entirety of the above-mentioned patent application is hereby incorporated by reference herein and made a part of specification.

### BACKGROUND OF THE INVENTION

1. Field of the Invention

The invention relates to a method of automatic updating and filtering information.

2. Description of the Related Art

As the development of the information technology and the popularity of the internet increases, the internet becomes the medium for information or message exchange in daily life. Instead of the conventional letters and post mails, the internet becomes the major information providing source. As the rapid exchange of information of the internet, the time interval between sending and receiving information is shortened, and the amount of the data is rapidly increased.

Conventionally, when a website is accessed on an electronic display device, such as a social networking service website, users has to manually refresh related web pages to download the most updated message or information that posted by other users (manually send a download signal to the server of the social networking service website). When the latest information is downloaded, the updated information is filtered according to the preferences of the user, and then the updated information is displayed on the webpages. However, repeatedly refreshing the related webpages to update the latest information is annoying to users.

### BRIEF SUMMARY OF THE INVENTION

A method of automatic updating and filtering information applied to an electronic display device is provided. The electronic display device includes a user interface, at least one detecting unit and a processing unit, and the user interface includes a first displaying zone and a second displaying zone. The method includes the following steps. First, the detecting unit generates a detecting signal according to an action of the electronic display device and transmits the detecting signal to the processing unit. Then, the processing unit downloads first update information and second information from a server according to a users' profile and the detecting signal. The priority of update order of the first update information is higher than the second update information. Then, the first update information and the second update information are respectively shown on the first displaying zone and the second displaying zone of the user interface.

### BRIEF DESCRIPTION OF THE DRAWINGS

FIG. 1 is a block diagram showing a method of automatic updating and filtering information applied to an electronic display device and a server;

FIG. 2 is a schematic diagram showing steps of a method of automatic updating and filtering information;

FIG. 3 is a schematic diagram showing that the user interface of the electronic display device displays the first update information and the second update information according to a method of automatic updating and filtering information in an embodiment;

FIG. 4 is a schematic diagram showing that user interface of the electronic display device displays the first update information and the second update information according to a method of automatic updating and filtering information in another embodiment;

FIG. 5 is a schematic diagram showing an electronic display device in an embodiment; and

FIG. 6 is a schematic diagram showing an electronic display device in another embodiment,

### DETAILED DESCRIPTION OF THE EMBODIMENTS

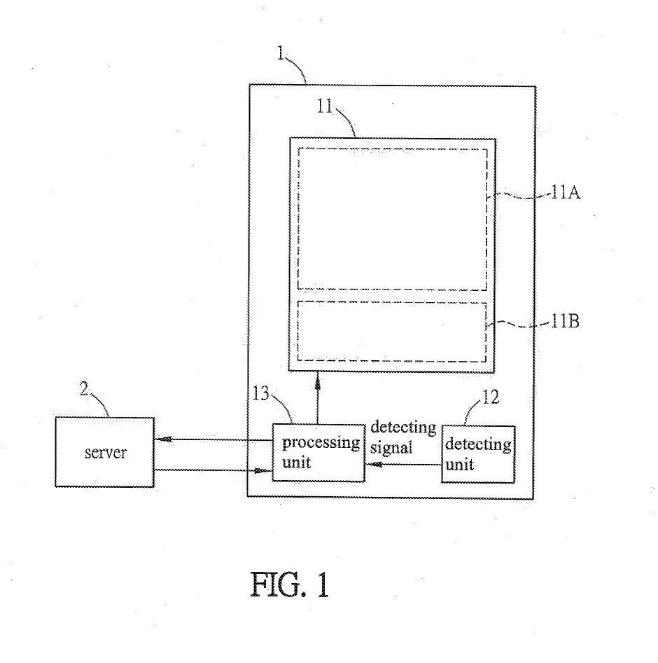

A method of automatic updating and filtering information applied to an electronic display device 1 is provided. As shown in FIG. 1, the electronic display device 1 includes a user interface 11, at least one detecting unit 12 and a processing unit 13. The user interface includes a first displaying zone 11A and a second displaying zone 11B. The detecting unit 12 is electrically connected to the processing unit 13 which sending and receiving related signals. In the embodiment, the detecting unit 12 may be one or a combination of a displacement detecting unit, a gravity detecting unit, a magnetic detecting unit and a light detecting unit, which is not limited herein. The electronic display device 1 may be a notebook computer, a tablet PC, a desktop PC or a smart phone, which is not limited herein.

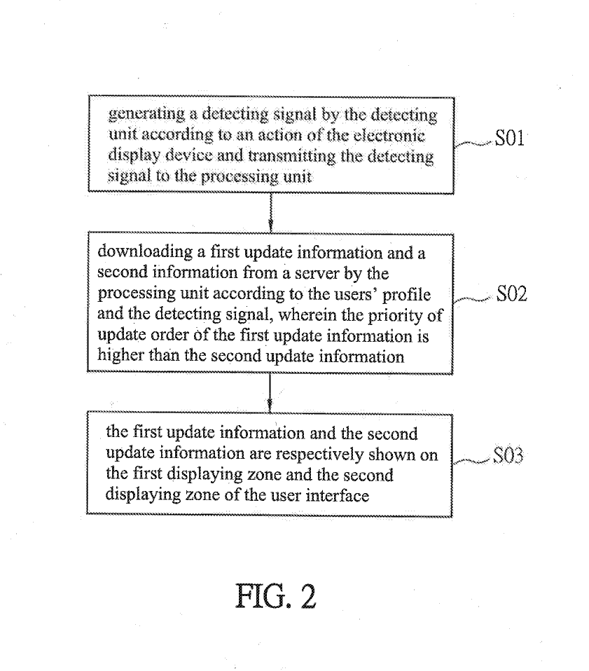

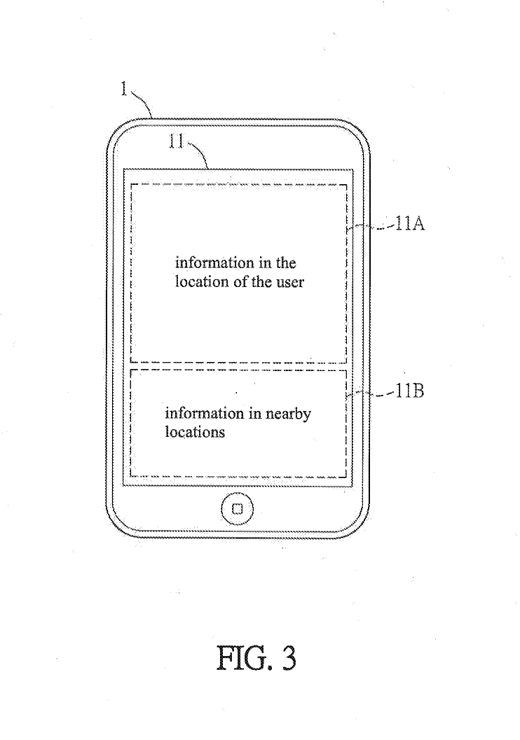

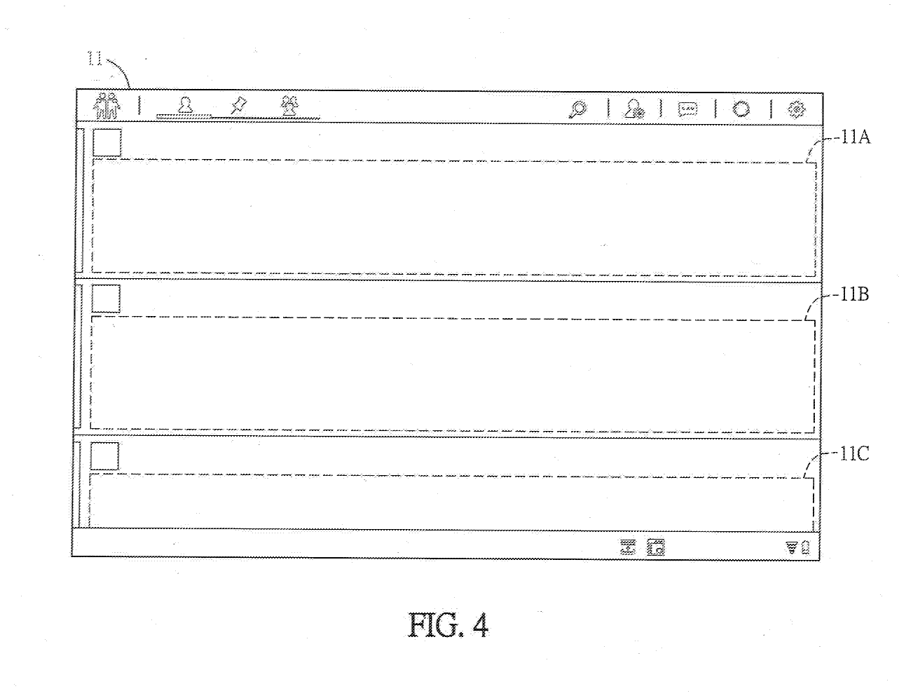

As shown in FIG. 2, in an embodiment, a method of automatic updating and filtering information includes the following steps. In step S01, a detecting signal is generated by the detecting unit 12 according to an action while the electronic display device is on, and the detecting signal is transmitted to the processing unit 13. In step S02, a first update information and a second update information are downloaded by the processing unit 13 from a server 2 according to the users' profile and the detecting signal, and the priority of updating the first update information is higher than that of the second update information. In step S03, the first update information and the second update information are respectively shown at the first displaying zone 11 A and the second displaying zone 11 B of the user interface 11. The displaying mode of the first update information and the second update information is shown in FIG. 3 and FIG. 4.

When the processing unit 13 downloads the information from the server 2 according to the users' profile, the processing unit 13 converts the users' profile to the users' profile signal and sends the users' profile signal to the server 2. The server 2 screens and filters to download the first update information and the second update information according to the users' profile signal. The first update information and the second update information are displayed on the user interface 11 according to the update order.

The priority of updating the first update information is higher than that of the second update information, which means the first update information is more accord with the demand of the user, and then the processing unit 13 determines that the first update information has a higher priority. In the embodiment, the information is divided into the first update information and the second update information, in other embodiments, the information can be divided into more parts within update orders of the users' profile, and displayed on the user interface 11 correspondingly.

If the electronic display device 1 automatically enters the standby status, the method of the disclosure further includes the step: transmitting a standby clear signal to the electronic display device 1 by the detecting unit 13 according to the action. The electronic display device 1 then executes the following steps in the method disclosed herein after the standby status is clear.

The users' profile in the step S02 includes positioning information, a custom category (which edits by the user) age. In an embodiment, if the electronic display device has a positioning function such as a GPS device, positioning coordinates or nearby landmarks are provided by the GPS to the processing unit 13, and the first update information and the second update information are downloaded according to the positioning coordinates or the nearby landmarks, and then the updated information is displayed in an order according to the user's preferences.

In another embodiment, the processing unit 13 may determine the order to filter the information as the first update information or the second update information according to stored images (such as the user's portrait or photos) or real time images. Users also can determine the order to filter or download the information as the first update information or the second update information according to a custom categories which may include editing and defining the users' profile (such as inputting filtering words and classes). Additionally, the users' profile also may be defined according to the preference of users s eh as the interaction frequency at the social networking service website or favorite articles), and the users' profile may be used as the reference for downloading and determining the order of the information as the first update information and the second update information next time.

The filtered updated information is displayed on the user interface 11 according to the user's preference or in an easy-reading mode, and the arrangement of the filtered updated information may be according to the interaction frequency, the refresh time or the correlation of coordinates.

As shown in FIG. 3, in the embodiment, the reading mode of the electronic display device 1 is from top to bottom. The first update information (the more interests information to users) is displayed on the big top zone (the first displaying zone 11A), and the second update information (the less interests information to users) is displayed on the small bottom zone (the second displaying zone 11B).

The first update information of the user interface 11 of the electronic display device 1 can be the information representing the position where the user located, and the second update information can be the information representing nearby locations. The information representing the position where the user located or the nearby locations include maps, scenic spots, vehicles information, local news, weather forecast and shopping information, which are not limited herein.

As shown in FIG. 4, in above step S02, the number of the server is not limited herein. In an embodiment, users can download the updated information from multiple servers according to the detecting signal, and arrange the updated information in a list mode according to the preference. In an embodiment, the updated information of multiple servers is displayed on the first displaying zone 11A, the second displaying zone 11B and the third displaying zone 11C according to the priority of the update order. The number of the server and the number of the displaying zone are not limited herein. In another embodiment, users can download the updated information from each server and arrange the information to be displayed on the first displaying zone 11A, the second displaying zone 11B and the third displaying zone 11C, respectively according to the preference of the servers (the priority of the update order). The updated information in the first displaying zone 11A, the second displaying zone 11B and the third displaying zone 11C further can be re-arranged according to the user's preference.

A server management unit (not shown) can be added in the method disclosed herein for the user to manage multiple servers, at a human-machine interface.

The “action” in the method disclosed herein is to reveal that the electronic display device 1 is going to be used. In other words, the “action” herein is different from the general action of the electronic display device 1. In the embodiment of the disclosure, the action type of the electronic display device 1 is different according to different detecting units 12. In an embodiment, if the detecting unit 12 is a displacement detecting unit, the detecting unit 12 generates and transmits a detecting signal to the processing unit 13 when a displacement amount is detected. If the detecting unit 12 is a gravity detecting unit, a magnetic detecting unit or a light detecting unit, the detecting unit 12 generates a detecting signal when acceleration amount, a changing amount of magnetic flux or a changing amount of light is detected, respectively

Furthermore, in accordance with the detecting units, a database is used herein. The database is to determine whether the user intends to operate the electronic display device 1 or not, which also avoids the electronic device from automatically updating when it is not been operated. The database is disposed in the detecting unit 12 which may be files or objects. The database includes varies parameters such as three-dimensional data parameters, or light intensity values that detected by the detecting unit 12 while the electronic display device 1 is intended to be used.

In an embodiment, if the detecting unit 12 is a gravity detecting unit, the database includes the three-dimensional data parameter of taking out the electronic display device 1 from different positions or places, such as a pocket, a desk or a bag.

In an embodiment, if the detecting unit 12 is a light detecting unit, the database includes a pre-defined light intensity value. According to the change of the light intensity value surrounding the electronic display device 1, the detecting unit 12 can determines whether the electronic display device 1 is going to be used. For example, when a mobile phone is taken out from a bag, the light intensity surrounding the phone is changed, and according to the change, the mobile phone downloads information automatically and prepare for use. If the detecting unit 12 is a distance detecting unit, the detecting unit 12 detects the distance between the electronic display device 1 and the nearby objects. In the embodiment, if the detecting unit detects that the distance between the electronic display device 1 and the nearby objects is changed, for example, becomes longer, it is determined that the electronic display device is going to be used, and the latest information is automatically downloaded and the electronic display device 1 is ready for use. The action is triggered according to the difference between the detected distance and the pre-defined distance value in database.

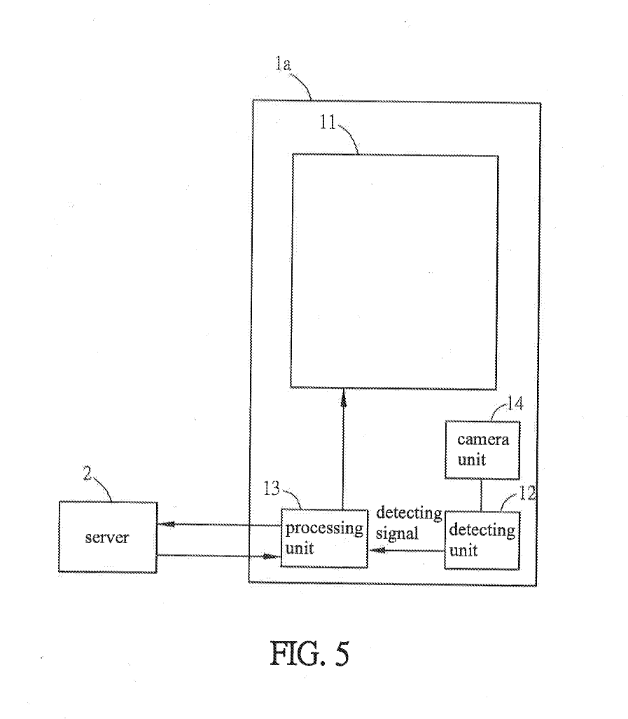

As shown in FIG. 5, FIG. 5 is a schematic diagram showing an electronic display device in an embodiment. The electronic display device 1a further includes a camera unit 14, such as a camera or an eye movement detecting component. The camera unit 14 can cooperate with the detecting unit 12 to determine and confirm the action of the electronic display device 1a.

In the embodiment, the step S01 further includes, generating an action detecting signal when the detecting unit 11 detects an action. The action includes a displacement, acceleration, a changing amount of light, a changing amount of magnetic flux in accordance with different detecting units. The camera unit 14 is enabled when the action detecting signal exceeds a default value. The camera unit 14 starts to capture the action image of a user, the action image includes an eye image, coordinates of eyes, a face image, an outline of a head and an outline of an upper body or the combinations of them, which is not limited herein. While the action image captured by the camera unit 14 complies a status of operating the electronic display device, which confirms that the electronic display device 1a is going to be used by a user, thus the detecting unit 12 is informed to generate a detecting signal to download the latest information.

In the above embodiment, when a detecting unit 12 cooperates with a camera unit 14, the camera unit 14 further confirms the position between the user and the electronic display device 1a after the detecting unit 12 detects the action. For example, the electronic display device la is confirmed to be operated when the user faces the camera unit 14, the detecting unit 12 is informed to generate a detecting signal, and then the step S02 is executed. With a confirm step that cooperates with the camera unit 14, the misjudgment of the action can be effectively avoid.

The connection between the other units and the components in embodiment are showed in FIG. 1, so the details are omitted herein. In addition, descriptions of well-known functions and constructions in this and other embodiments are known in the art, detailed descriptions thereof are omitted for clarity and conciseness.

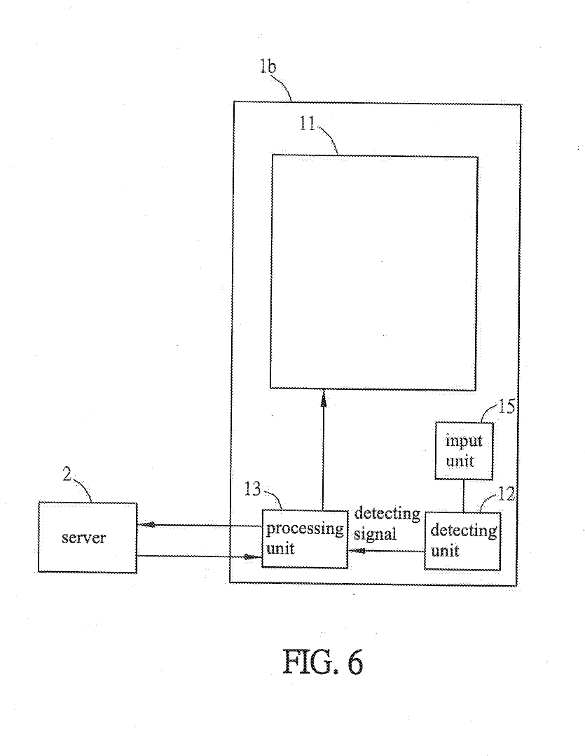

FIG. 6 is a schematic diagram showing an electronic display device in an embodiment. In comparison with the electronic display device showed in FIG. 5, the electronic display device lb in FIG. 6 further includes an input unit 15. The input unit 15 cooperates with the detecting unit 12, and the input unit 15 may be a touchable input unit or a physical key button.

In the embodiment, the step SOI further includes the step that generating a detecting signal by the detecting unit 2 according to the action of the electronic display device 1b and an input signal received by the input unit 15. The input signal may be a touch signal or a current signal. After the detecting unit 12 detects an action, an input signal from touching any position on the user interface 11 or pressing any key is required to confirm the action, and then the detecting unit 12 generates the detecting signal, and the step S02 is executed. Similarly, with the confirm step in accordance with the input unit 15, the misjudgment of the action can be effectively avoid.

The connection between the other units and the components in the embodiment is the same as that in the previous embodiments, so the details are omitted herein.

In conclusion, the detecting unit disclosed in the electronic display device herein detects an action of the electronic display device, thus to automatically update and filter information without manually execution, which provides users more convenient and intuitive operation.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described, above.

What is claimed is:

1. A method of automatic updating and filtering information, applied to an electronic display device, wherein the electronic display device includes a user interface, at least one detecting unit and a processing unit, the user interface includes a first displaying zone and a second displaying zone, the method comprising:
generating a detecting signal by the detecting unit according to an action of the electronic display device;
transmitting the detecting signal to the processing unit;
downloading a first update information and a second information from a server by the processing unit according to a users' profile and the detecting signal, wherein the priority of the first update information is higher than that of the second update information; and
wherein the first update information and the second update information are respectively shown on the first displaying zone and the second displaying zone.

2. The method of automatic updating and filtering information according to claim 1, wherein the detecting unit includes one or a combination of a. displacement detecting unit, a gravity detecting unit, a magnetic detecting unit and a light detecting unit.

3. The method of automatic updating and filtering information according to claim 2, wherein the action includes one or a combination of a displacement amount, acceleration amount, a changing amount of light, and a changing amount of magnetic flux.

4. The method of automatic updating and filtering information according to claim 1, wherein the electronic display device further includes a camera unit, the step that generating a detecting signal by the detecting unit according to the action of the electronic display device further includes:
generating an action detecting signal by the detecting unit when the action is detected;
enabling a camera unit when the action detecting signal exceeds a default value;
capturing an action image of the user by the camera unit; and
generating the detecting signal by the detecting unit if the action image of the user is a status of using the electronic display device.

5. The method of automatic updating and filtering information according to claim 4, wherein the action image includes one or a combination of an image of eyes, coordinates of eyes, an image of a face, an outline of a head, and an outline of an upper body.

6. The method of automatic updating and filtering information according to claim 1, wherein the electronic display device further includes an input unit, the step that generating a detecting signal by the detecting unit according to an action of the electronic display device further includes that:
generating a detecting signal by the detecting unit according to the action of the electronic display device and an input signal received from the input unit.

7. The method of automatic updating and filtering information according to claim 6, wherein the input unit is a touch unit or a key button.

8. The method of automatic updating and filtering information according to claim 1, wherein the users' profile includes positioning information, a custom categories or an image of users'.

9. The method of automatic updating and filtering information according to claim 1 further comprising:
transmitting a standby clear signal to the electronic display device by the detecting unit according to the action of the electronic display device.

10. The method of automatic updating and filtering information according to claim 3, wherein the detecting unit includes a database, and the database includes three-dimensional data parameters and light intensity values.
